(19) United States
(12) Patent Application Publication
(10) Pub. No.: US 2020/0366122 A1
(43) Pub. Date: Nov. 19, 2020

(54) SELF-CHARGING ELECTRIC POWER GENERATOR

(71) Applicant: VTech Innovative Solutions, LLC, Ocala, FL (US)

(72) Inventor: Paul Vette, Ocala, FL (US)

(21) Appl. No.: 16/871,682

(22) Filed: May 11, 2020

Related U.S. Application Data
(60) Provisional application No. 62/847,058, filed on May 13, 2019.

(51) Int. Cl. H02J 7/14

(52) U.S. Cl. CPC H02J 7/1476; H02J 7/1492

(57) ABSTRACT

A self-charging and powered electricity generating apparatus, method and/or system. The apparatus includes a first mechanism, such as a generator/alternator (for AC) or a dynamo (for DC) and a second mechanism for delivering or applying mechanical energy via a pressurized medium to the generator/alternator or dynamo. The second mechanism delivers sufficient mechanical energy to the generator/alternator or dynamo for the generator/alternator or dynamo to create and deliver electricity to power the second mechanism and also supply surplus electric power/energy.

### CROSS-REFERENCE TO RELATED APPLICATIONS

This application claims priority to U.S. Provisional Application No. 62/847,058, having a filing date of May 13, 2019, the entire contents of which are incorporated herein by reference.

### FIELD OF TECHNOLOGY

The following disclosure relates generally to apparatuses, systems and methods for generating electricity or power. More specifically, the following disclosure relates to apparatuses, systems and methods for the generating of electricity by a self-powered apparatus.

### BACKGROUND

Access to electricity or power is critical for modern life. Access to energy is central to issues such as security, climate change, food production, and strengthening economies while protecting ecosystems. Increased access to electricity improves education, entertainment, health, comfort, protection, and productivity. Currently, access to electricity generally comes from energy service providers through electrical grid networks. However, disastrous consequences can result when these electrical grids fail.

Currently, users who are aware of the importance of constant access to electricity generally turn to generators to fill in when electrical grid networks fail. Traditional generators require some external source, such as fuel or coal, to run. However, these external sources are finite such that users may run out during an extended failure of the electrical grids, leaving users with no access to electricity. Additionally, traditional external sources such as oil or coal emit harmful pollution when used. As such, generating electricity, especially without using a fuel/coal or another external source, is highly desirable.

Thus, a self-powered electric power generator which generates electricity without the use of an external source would be well received in the art.

### SUMMARY

According to one embodiment, the self-powered electric power generator includes a first mechanism and a second mechanism. The first mechanism outputs electric energy by converting mechanical energy into electric energy. The second mechanism supplies mechanical energy to the first mechanism. The second mechanism is powered by the electric energy created by the first mechanism, wherein that the second mechanism supplies mechanical energy to the first mechanism such that the first mechanism continuously creates and transmits electric power to operate the second mechanism and any excess electric power created by the first mechanism is transmitted to other devices or stored in a battery.

According to a second embodiment, the self-powered electric power generator includes a grid having a plurality of generators. A pump is connected to the grid wherein the pump forces the flow of a medium through the grid such that the medium provides mechanical energy to the plurality of generators by rotating the generators. The pump is powered by the electrical energy produced by the plurality of generators or by a battery charged by the plurality of generators, such that the pump can continuously force the medium through the grid.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 depicts a first embodiment of the self-powered electric power generator;

FIG. 2 depicts a second embodiment of the self-powered electric power generator;

FIG. 3 depicts a third embodiment of the self-powered electric power generator; and

FIG. 4 depicts a fourth embodiment of the self-powered electric power generator.

### DETAILED DESCRIPTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

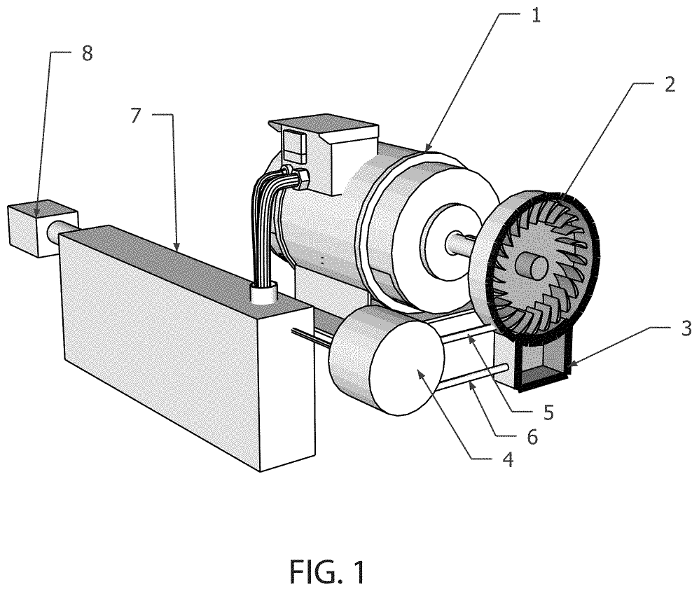

Referring to the drawings, FIG. 1 depicts a first embodiment of the self-powered electric power generator. The self-powered electric power generator includes a first mechanism 1. The first mechanism 1 is a device which is capable of converting mechanical energy into electrical energy. In other words, the first mechanism 1 is capable of producing electrical energy when a mechanical advantage is transmitted or applied. The first mechanism 1 may be a generator, an alternator, a dynamo, a turbine, a hydroelectric generator, or any other suitable device for converting mechanical energy into electrical energy. The first mechanism may be a generator or alternator when AC current is desired. The first mechanism may be a dynamo when DC current is desired.

The first mechanism 1 may convert rotational mechanical energy into electrical energy. However, other forms of mechanical energy may also be used, such as linear mechanical energy. The first mechanism may include a drive wheel 2. The drive wheel 2 is attached to a shaft of the first mechanism 1. The drive wheel 2 transmits rotational mechanical energy to the first mechanism 1 via the shaft. The drive wheel 2 may include paddles, blades, or any other suitable device attached to the shaft of the first mechanism 1 in order to spin the shaft and provide rotational mechanical energy to the first mechanism 1.

The self-powered electric power generator includes a second mechanism 4. The second mechanism 4 transmits, supplies, creates, or otherwise generates mechanical energy to be provided to the first mechanism. The second mechanism 4 may be a pump, a hydraulic or pneumatic cylinder, a fan, a magnet drive or pump, an electrical drive or pump, a steam pump, or any other suitable device capable of providing sufficient mechanical energy to the first mechanism 1. The mechanical energy may be provided to the drive wheel 2 by the second mechanism 4 to rotate the shaft of the first mechanism by force, pressure, by a volume of a pressurized medium, or by another other appropriate means. The pressurized medium may be a liquid, gas, solid, solid particles, gel, or any suitable combination thereof. The pressurized medium may also be pulsated.

In the embodiment shown in FIG. 1, the second mechanism 4 transmits a pressurized medium to the drive wheel 2. The pressurized medium is stored in a reservoir 3. The pressurized medium is provided to the second mechanism 4 through a tube 6 which may be a recirculating pickup tube. The second mechanism 4 pressurizes the pressurized medium and provides the pressurized medium to the drive wheel 2 through a pipe 5. The pressurized medium provides mechanical energy to the drive wheel 2 such that the drive wheel 2 is rotated, which in turn rotates the shaft of the first mechanism 1, thereby providing mechanical energy to the first mechanism.

The first mechanism 1 should be capable of generating surplus or excess electrical energy exceeding what is required to sufficiently power or operate the second mechanism 4, such that mechanical energy is continuously transmitted to the first mechanism 1 by the second mechanism 4.

The electrical energy produced by the first mechanism 1 may be transmitted to or stored in a battery 7. The battery 7 may be a battery, a battery pack, multiple batteries, a cell, a capacitor, or any other suitable electrical energy storage device. The electrical energy produced by the first mechanism is transmitted to the battery 7 through cables, cords, wires, or other suitable transmission means. The electrical energy may then be stored in the battery 7 for use on demand by other devices or mechanisms. The electrical energy may also be transmitted to the second mechanism 4 to power the second mechanism 4 such that mechanical energy is continually supplied to the first mechanism 1, as described above. The excess electrical energy not consumed by the second mechanism 4 may be stored in the battery 7 or transmitted to other devices or mechanisms. The battery 7 may store electrical energy to be used to start the second mechanism 4 prior to the first mechanism 1 producing any electrical energy, such that the second mechanism 4 is able to provide mechanical energy to the first mechanism 1 prior to the first mechanism 1 producing any electrical energy to run the second mechanism 4.

A converter 8 is also provided to supply electrical energy other devices or mechanisms in a suitable form. The converter 8 may be an AC/DC converter. The converter 8 may also include an electrical receptacle, such as a plug or USB port, for other devices or mechanisms to receive electrical energy from the self-powered electric power generator. The converter 8 may also provide a means for transferring electrical energy from the battery via a wire, a cable, a conduit, or other means of transferring electricity.

In another embodiment, the self-powered electric power generator may not include a battery 7. The first mechanism 1 may provide electrical energy directly to the second mechanism 4 while providing the excess or surplus electrical energy directly to other devices or mechanisms.

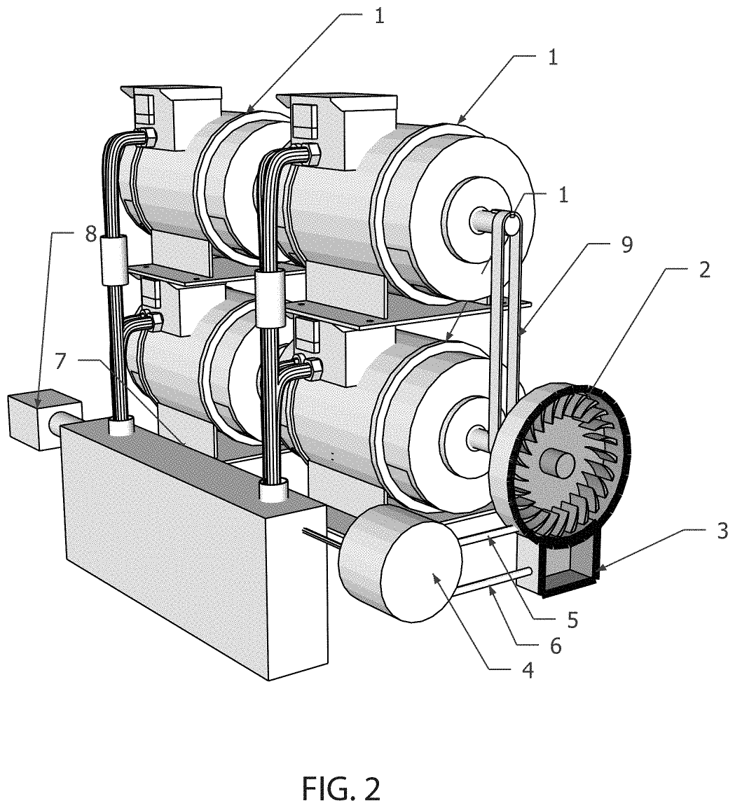

FIG. 2 depicts a second embodiment of the self-powered electric power generator. In this embodiment, there are a plurality of first mechanism 1. The plurality of first mechanism 1 all receive the mechanical energy from a single second mechanism 4, similar to that of FIG. 1. In other embodiments there may be a plurality of second mechanism 4 and related structure.

The plurality of first mechanism 1 may be connected by a shaft or a drive belt 9. The drive belt 9 may be a belt, a gear assembly, or other appropriate devices or mechanisms for transferring the mechanical energy from a first shaft to a second shaft. As shown in FIG. 2, the plurality of first mechanism 1 may be connected by either a single shaft or a drive belt 9. For example, the two lower first mechanism 1 and the two upper first mechanism 1 of FIG. 2 are each connected by a single shaft. As such, when that shaft rotates, it provides mechanical energy to both first mechanism 1 (i.e., when the lower shaft rotates is provides mechanical energy to both of the lower first mechanism 1). The shafts may be connected by a drive belt 9, as shown in FIG. 2. The drive belt 9 transfers the mechanical energy of one shaft to another shaft. As shown in FIG. 2, the lower shaft receives mechanical energy from the drive wheel 2, which received the mechanical energy from the second mechanism 4. As the lower shaft rotates, the drive belt 9 will be rotated in turn. As drive belt 9 rotates, it transfers the mechanical energy received from the lower shaft to the upper shaft.

Through the assembly shown in FIG. 2, a single second mechanism 4 may provide the mechanical energy for a plurality of first mechanism 1. This results in increased efficiency and a larger amount of surplus or excess electrical energy to be stored in the battery 7 or transferred to other devices or mechanisms.

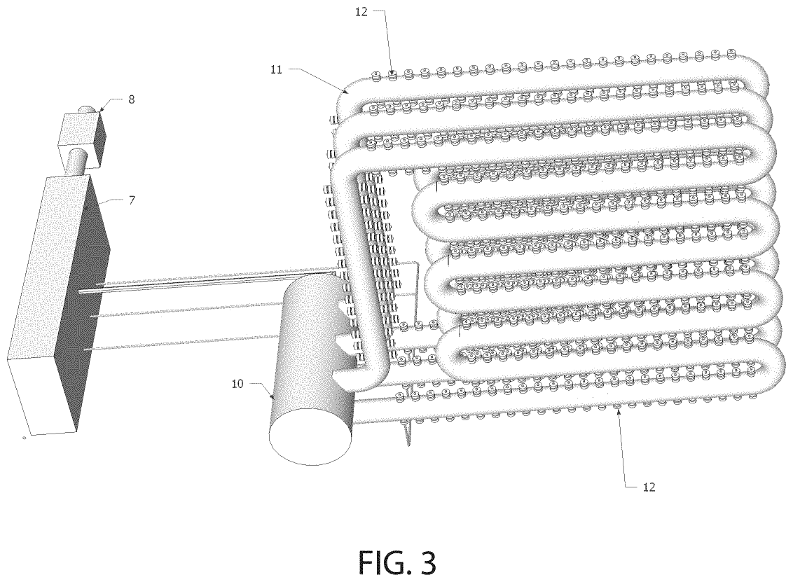

FIG. 3 depicts a third embodiment of the self-powered electric power generator. The third embodiment includes a grid 11 having a plurality of generators 12. The grid 11 is a sealable container. For example, the grid 11 may be a pipe, a conduit, a tube, a channel, a pipeline, a duct, or other suitable sealable containers. The generator 12 is a device capable of converting mechanical energy to electrical energy. For example, the generator 12 may be a hydroelectric generator, a wind or air generator, a dynamo, a turbine, a generator, or other suitable devices for converting mechanical energy into electrical energy.

Mechanical energy is provided to the plurality of generators 12 by a medium flowing through the grid 11. For example, the medium may be water, liquid, gas, forced or compressed air, pressurized fluid, compressed fluid, or any other suitable medium for providing mechanical energy to the plurality of generators 12. The generators 12 may be rotated by the medium flowing through the grid 11.

The flow of the medium through the grid 11 may be a passive flow. For example, the flow may be generated from water supply or plumbing. In another embodiment, the flow of the medium through the grid 11 is generated by a pumping mechanism, such as pump 10. The pump 10 may be a pump, a hydraulic or pneumatic cylinder, a fan, a magnet drive or pump, an electrical drive or pump, a steam pump, or any other suitable device capable of providing sufficient mechanical energy to force the medium through the grid 11. The pump 10 may be powered directly by the electrical energy provided by the plurality of generators 12. In other embodiments, the pump 10 may be powered by the battery 7 or other electrical energy storing devices which are charged by the plurality of generators 12.

Each of the plurality of generators 12 are connected to a battery 7, such that electrical energy is transferred to or stored in the battery 7. The battery 7 may be a battery, a battery pack, multiple batteries, a cell, a capacitor, or any other suitable electrical energy storage device. As shown in FIG. 3, each of the plurality of generators 12 may be connected to a single battery 7. In other embodiments, each of the plurality of generators 12 may be connected to their own battery 7. In yet another embodiment, there may be a plurality of batteries 7 wherein a subset of the plurality of generators 12 are connected to each battery 7 such that each of the plurality of batteries 7 receives electrical energy from more than one generator 12. In yet another embodiment, no batteries may be used and the plurality of generators 12 may be directly connected to the pump 10 and to other devices or mechanisms.

As shown in FIG. 3, a converter 8 is also provided to supply electrical energy other devices or mechanisms in a suitable form. The converter 8 may be an AC/DC converter. The converter 8 may also include an electrical receptacle, such as a plug or USB port, for other devices or mechanisms to receive electrical energy from the self-powered electric power generator.

In one embodiment, an additional mechanism, such as a pressure increasing mechanism or a flow restricting mechanism may also be used within the grid 11. For example, the additional mechanism may be one or more venturis. The additional mechanism may be situated within the grid 11 to increase the pressure or velocity of the medium, thereby increasing or accelerating the force on the plurality of generators 12 forcing them to spin or rotate faster, thus increasing the electricity generated. There may be a plurality of the additional mechanisms placed throughout the grid 11. For example, there may be an additional mechanism placed directly before each of the plurality of generators 12.

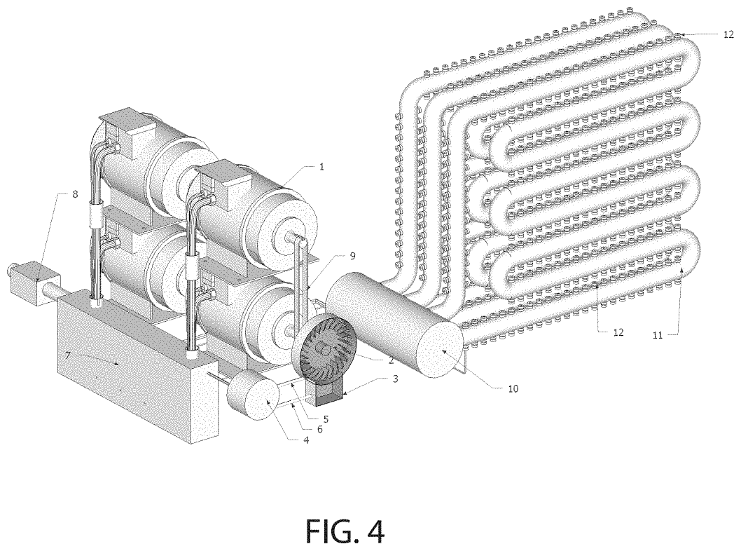

FIG. 4 depicts a fourth embodiment of the self-powered electric power generator. As shown in FIG. 4, the embodiments described above with respect to FIGS. 2 and 3 may be used in combination with one another. For example, the plurality of first mechanism 1 and the plurality of generators 12 may each provide electrical energy to the same battery 7. As described above, there may also be a plurality of batteries 7 or no batteries at all.

By combining the embodiments as shown in FIG. 4, a plurality of excess or surplus electrical energy may be produced. This may allow for the self-powered electric power generator to provide greater amounts of energy to other devices or mechanisms. For example, in some uses, the embodiments described above with FIGS. 1 and 3 may be suitable where less energy is required for the use, such as with personal uses, single home uses, or other lower energy uses. These embodiments (shown in FIGS. 1 and 3) would be desirable because they are smaller and have a lower cost. However, where larger amounts energy are required by users, the embodiment of FIG. 4 would be desirable due to the increased excess electrical energy this embodiment would produced when compared with previous embodiments discussed.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims. Moreover, it should be understood that the present invention may include any combination of the components, hierarchy and methodology described herein.

1. A self-powered electric power generator comprising:
a first mechanism, wherein the first mechanism converts mechanical energy into electrical energy;
a second mechanism, wherein the second mechanism provides mechanical energy to the first mechanism; and
a battery, wherein the battery stores the electrical energy produced by the first mechanism;
wherein the second mechanism is powered by the electrical energy produced by the first mechanism and excess electrical energy produced by the first mechanism is stored in the battery or provided directly to other devices or mechanisms.

2. The self-powered electric power generator of claim 1 wherein the first mechanism is a generator and the second mechanism is a pump.

3. The self-powered electric power generator of claim 2 further comprising a pressurized medium wherein the pump pressurizes the pressurized fluid and forces the pressurized fluid through a drive wheel, wherein the drive wheel is attached to a shaft of the generator such that the pressurized fluid rotates the drive wheel, thereby rotating the shaft and providing mechanical energy to the generator.

4. A self-powered electric power generator comprising:
a grid, wherein the grid is a sealable housing;
a plurality of generators included on the grid;
a pump, wherein the pump forces a medium through the grid such that the medium transfers mechanical energy to the plurality of generators; and
a battery;
wherein the pump is powered by the plurality of generators or by the battery after being charged by the plurality of generators such that the pump is able to continuously force the medium through the grid;
wherein excess electrical energy after powering the pump is stored in the battery or provided directly to other devices or mechanisms.
